(19) United States
(12) Patent Application Publication
(10) Pub. No.: US 2025/0299889 A1
(43) Pub. Date: Sep. 25, 2025

(54) SOLID ELECTROLYTIC CAPACITOR ELEMENT AND SOLID ELECTROLYTIC CAPACITOR

(71) Applicant: Panasonic Intellectual Property Management Co., Ltd., Osaka (JP)

(72) Inventors: Naoki UMAHASHI, OSAKA FU (JP); Kei HIROTA, OKAYAMA KEN (JP); Takahiro YOSHII, OSAKA FU (JP)

(21) Appl. No.: 19/229,074

(22) Filed: Jun. 5, 2025

Related U.S. Application Data
(63) Continuation of application No. PCT/JP2023/045459, filed on Dec. 19, 2023.

(30) Foreign Application Priority Data
Dec. 21, 2022 (JP) 2022-204276

(51) Int. Cl. H01G 9/028; H01G 9/042; H01G 9/055; H01G 9/07; H01G 9/15

(52) U.S. Cl. CPC H01G 9/028; H01G 9/0425; H01G 9/055; H01G 9/07; H01G 9/15

(57) ABSTRACT

A solid electrolytic capacitor element includes an anode body having a porous portion in at least a surface layer thereof, a dielectric layer covering at least a part of the anode body, and a cathode portion covering at least a part of the dielectric layer. The cathode portion includes a solid electrolyte layer covering at least a part of the dielectric layer. The solid electrolyte layer contains a nitrogen element N, a sulfur element S, a carbon element C, and an oxygen element O, and has a first portion filled in voids of the porous portion of the anode body covered with the dielectric layer, and a second portion protruding from the main surface of the anode body covered with the dielectric layer. A mass ratio: N/S of the nitrogen element N to the sulfur element S in the second portion is 0.30 or more and 1.00 or less.

### CROSS REFERENCE TO RELATED APPLICATION

The present application is a continuation application of International Application No. PCT/JP2023/045459, filed on Dec. 19, 2023, and claims priority with respect to the Japanese Patent Application No. 2022-204276, filed on Dec. 21, 2022. The entire contents of these prior applications are incorporated herein by reference.

### TECHNICAL FIELD

The present disclosure relates to a solid electrolytic capacitor element and a solid electrolytic capacitor.

### BACKGROUND

A solid electrolytic capacitor includes a solid electrolytic capacitor element, a resin outer housing or case that seals the solid electrolytic capacitor element, and an external electrode electrically connected to the solid electrolytic capacitor element. The solid electrolytic capacitor element includes an anode body, a dielectric layer formed on the surface of the anode body, and a cathode portion covering at least a part of the dielectric layer, for example. The cathode portion contains a conductive polymer (e.g., a conjugated polymer and a dopant) covering at least a part of the dielectric layer. The conductive polymer is also referred to as a solid electrolyte.

Patent Document 1 (WO 2014/087617) proposes a method of producing a solid electrolytic capacitor including a capacitor element including a dielectric layer and a solid electrolyte layer, wherein formation of the solid electrolytic capacitor layer includes: a first step of forming a first conductive polymer layer by applying a first conductive polymer solution in which fine particles of a conductive polymer are dispersed, followed by drying; a second step of applying a coating solution to the first conductive polymer layer, followed by drying, the coating solution containing at least one selected from an aromatic sulfonic acid having a carboxyl group and a hydroxy group or two carboxyl groups in one molecule, and a salt thereof; and a third step of forming a second conductive polymer layer by applying a second conductive polymer solution in which fine particles of a conductive polymer are dispersed, followed by drying. As the coating solution, a solution containing a cation of an amine compound is used.

Patent Document 2 (Japanese Laid-Open Patent Publication No. 2009-54925) proposes a conductive polymer capacitor characterized in that the ratio α/(Al+N+S+α) of the numbers of atoms in a cross section of an electrode is 0.01 or less, where a represents the number of cationic atoms constituting an oxidizer, and Al, N, and S represents the numbers of atoms of aluminum, nitrogen, and sulfur, respectively.

### SUMMARY

When a solid electrolyte layer contains a nitrogen (N) element derived from, for example, an amine compound and a sulfur(S) element derived from, for example, a sulfonic acid compound, equivalent series resistance (ESR) may increase in some cases after the solid electrolytic capacitor is exposed to a high-temperature and high-humidity environment.

A first aspect of the present disclosure relates to a solid electrolytic capacitor element that includes:
an anode body having a porous portion at least in a surface layer thereof,
a dielectric layer covering at least a part of the anode body, and
a cathode portion covering at least a part of the dielectric layer, wherein
the cathode portion includes a solid electrolyte layer covering at least a part of the dielectric layer,
the solid electrolyte layer contains a nitrogen element N, a sulfur element S, a carbon element C, and an oxygen element O, and has a first portion filled in voids of the porous portion of the anode body covered with the dielectric layer, and a second portion protruding from a main surface of the anode body covered with the dielectric layer, and
a mass ratio: N/S of the nitrogen element N to the sulfur element S in the second portion is 0.30 or more and 1.00 or less.

A second aspect of the present disclosure relates to a solid electrolytic capacitor including at least one solid electrolytic capacitor element, the at least one solid electrolytic capacitor element being the solid electrolytic capacitor element described above.

According to the present disclosure, an increase in ESR of the solid electrolytic capacitor after exposure to a high-temperature and high-humidity environment can be suppressed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a schematic cross-sectional view of a solid electrolytic capacitor according to an embodiment of the present disclosure.

FIG. 2 is a schematic front view of a solid electrolytic capacitor element as viewed from one main surface side.

FIG. 3 is a schematic cross-sectional view of the solid electrolytic capacitor element of FIG. 2 taken along III-III line, as viewed in the direction of the arrow.

### DETAILED DESCRIPTION

In formation of a solid electrolyte layer with a treatment liquid containing a conductive polymer, treatment liquid coating needs to be repeated multiple times in order that the formed solid electrolyte layer has a certain thickness. However, electrostatic repulsion of an anionic group of, for example, a dopant contained in the conductive polymer makes it difficult to attach the conductive polymer onto a solid electrolyte layer. When a cationic agent such as an amine compound or a salt of a cationic agent and an anionic agent such as a sulfonic acid compound is attached to a solid electrolyte layer as described in Patent Document 1, a conductive polymer tends to be attached when the treatment liquid is applied. The solid electrolyte layer formed as above contains a nitrogen element derived from the cationic agent and a sulfur element derived from the anionic agent. However, it has been found that when the solid electrolytic capacitor is exposed to a high-temperature and high-humidity environment, the balance of the mass ratio: N/S between the nitrogen element N to the sulfur element S in the solid electrolyte layer affects ESR of the solid electrolytic capacitor.

An increase in ESR of the solid electrolytic capacitor is considered to be based on an increase in intrinsic resistance, since the solid electrolyte layer swells through moisture absorption by a component derived from the cationic agent in the solid electrolyte layer, in a high-temperature and high-humidity environment. The cathode portion may include a solid electrolyte layer and a cathode leading layer covering the solid electrolyte layer. In a high-temperature and high-humidity environment, the intrinsic resistance of the cathode leading layer (e.g., a metal particle-containing layer included in the cathode leading layer) may be increased by the action of a component derived from, for example, an anionic agent in the solid electrolyte layer. This is also considered to increase ESR of the solid electrolytic capacitor.

### Technique (1)

A solid electrolytic capacitor element according to a first aspect of the present disclosure includes: an anode body having a porous portion at least in a surface layer thereof; a dielectric layer covering at least a part of the anode body, and a cathode portion covering at least a part of the dielectric layer. The cathode portion includes a solid electrolyte layer covering at least a part of the dielectric layer. The solid electrolyte layer contains a nitrogen element N, a sulfur element S, a carbon element C, and an oxygen element O, and has a first portion filled in voids of the porous portion of the anode body covered with the dielectric layer, and a second portion protruding from a main surface of the anode body covered with the dielectric layer. A mass ratio: N/S of the nitrogen element N to the sulfur element S in the second portion is 0.30 or more and 1.00 or less. Hereinafter, the solid electrolytic capacitor element may be sometimes referred to as capacitor element.

In the present disclosure, as a result of the N/S ratio being within the above range, the amount of moisture absorbed by the solid electrolyte layer when the solid electrolytic capacitor is exposed to a high-temperature and high-humidity environment can be reduced, thereby achieving suppression of an increase in intrinsic resistance. In addition, an increase in intrinsic resistance of the cathode leading layer (e.g., a metal particle-containing layer) due to the presence of a component derived from an anionic agent, such as a sulfonic acid compound can be suppressed. Therefore, an increase in ESR of the solid electrolytic capacitor when exposed to a high-temperature and high-humidity environment can be suppressed. It is considered that an increase in the intrinsic resistance is suppressed because interaction between the nitrogen element-containing component derived from a cationic agent and the sulfur element-containing component derived from the anionic agent reduces, for example, the amount of absorbed moisture and/or the effect on the cathode leading layer. By contrast, when the N/S ratio is less than 0.30, the intrinsic resistance of the cathode leading layer (e.g., a metal particle-containing layer) increases. When the N/S ratio exceeds 1.00, the amount of moisture absorbed by the solid electrolyte layer is increased to increase the intrinsic resistance. Thus, ESR when the solid electrolytic capacitor is exposed to a high-temperature and high-humidity environment is increased in both cases.

### Technique (2)

In Technique (1) described above, a mass ratio: N/(C+O+S) of the nitrogen element N to a total amount of the carbon element C, the oxygen element O, and the sulfur element S in the second portion may be 0.033 or more and 0.050 or less. As a result of the N/(C+O+S) ratio being within such a range, a certain thickness of the solid electrolyte layer can be easily ensured so that a decrease in conductivity of the conductive polymer can be suppressed to suppress an increase in ESR. In addition, quantitative balance between the cationic agent and the anionic agent with respect to the conductive polymer can be easily achieved, and an increase in intrinsic resistance of the solid electrolyte layer and the cathode leading layer (e.g., a metal particle-containing layer) when exposed to a high-temperature and high-humidity environment can be further suppressed. Thus, variation in ESR of the solid electrolytic capacitor can be also suppressed.

### Technique (3)

In Technique (1) or Technique (2) described above, a maximum thickness of the second portion may be 15 μm or more and 42 μm or less. When the solid electrolytic capacitor is exposed to a high-temperature and high-humidity environment, degradation or dedoping of the conductive polymer may be caused, decreasing conductivity. Such a decrease in conductivity is likely to occur, starting from the outer region of the solid electrolyte layer. As a result of the maximum thickness of the second portion being 15 μm or more, high conductivity can be maintained in the inner region and an increase in ESR can be suppressed even when the conductivity of the outer region of the solid electrolyte layer decreases. As a result of the maximum thickness of the second portion being 42 μm or less, a higher capacity can be achieved.

### Technique (4)

In any one of Techniques (1) to (3) described above, the anode body has an anode leading portion having a first end and a cathode-forming portion having a second end. In a cross section, taken at an arbitrary position of a part of the solid electrolyte element on the side of the first end, perpendicular to a direction from the first end to the second end, a ratio: T1/T2 of a thickness T1 of the second portion at a corner of the anode body to a thickness T2 of the second portion at a central part of the anode body may be 0.8 or more and 1.7 or less. Through reduction of variation in thickness of the solid electrolyte layer over the entire surface of the cathode-forming portion of the anode body, spread in variation of conductivity of the solid electrolytic capacitor layer when the solid electrolytic capacitor is exposed to a high-temperature and high-humidity environment is suppressed, and an increase in ESR, a decrease in capacity, and the like are suppressed. As a result, the quality of the solid electrolytic capacitor is further stabilized.

### Technique (5)

In any one of Techniques (1) to (4) described above, the cathode portion may include a cathode leading layer covering at least a part of the solid electrolyte layer. The cathode leading layer may include a metal particle-containing layer. In a high-temperature and high-humidity environment, the cathode leading layer (particularly, the metal particle-containing layer) is likely to degrade due to the presence of a component derived from a sulfonic acid compound contained in the solid electrolyte layer, and thus the conductivity is likely to be decreased. However, in the present disclosure, since the N/S ratio of the second portion is within the specified range, degradation of the cathode leading layer (e.g., the metal particle-containing layer) can be suppressed and high conductivity can be ensured, thereby suppressing ESR at a low level.

### Technique (6)

In any one of Techniques (1) to (5) described above, the second portion may contain a conjugated polymer and a dopant. The conjugated polymer may contain a monomer unit corresponding to a thiophene compound, and the dopant may have a sulfo group. When the second portion contains the conjugated polymer and the dopant such as above, an increase in ESR in a high-temperature and high-humidity environment can be further suppressed by the N/S ratio being the above range.

### Technique (7)

The present disclosure also encompasses a solid electrolytic capacitor including at least one capacitor element, the at least on capacitor element being the capacitor element according to any one of Techniques (1) to (6) described above.

Hereinafter, the solid electrolytic capacitor and the capacitor element of the present disclosure will be described more specifically, including Techniques (1) to (7) described above. At least one selected from the elements of configuration described below can be optionally combined with at least one of Techniques (1) to (7) according to the solid electrolytic capacitor of the present disclosure described above, so long as it can be technically combined.

### [Solid Electrolytic Capacitor]

The solid electrolytic capacitor includes one or two or more capacitor elements.

### [Capacitor Element]

A capacitor element included in the solid electrolytic capacitor includes an anode body, a dielectric layer covering at least a part of the anode body, and a cathode portion covering at least a part of the dielectric layer. The cathode portion includes a solid electrolyte layer covering at least a part of the dielectric layer.

### (Anode Body)

The anode body may contain, for example, any of a valving metal, an alloy containing a valving metal, and a compound (e.g., an intermetallic compound) containing a valving metal. Any of these materials may be used alone or in combination of two or more of them. Examples of the valving metal include aluminum, tantalum, niobium, and titanium.

The anode body may be a foil (anode foil) of a valving metal, an alloy containing a valving metal, or a compound containing a valving metal, or may be a shaped body (porous shaped body) of particles of a valving metal, an alloy containing a valving metal, or a compound containing a valving metal, or a sintered body (porous sintered body) thereof.

The anode body includes an anode leading portion having a first end, and a cathode-forming portion having a second end opposite to the first end. The cathode portion including the solid electrolyte layer is formed on the surface of the cathode-forming portion of the anode body. The anode leading portion is used for electrical connection with an anode side external electrode, for example. An anode lead terminal may be connected to the anode leading portion.

The anode body has a porous portion at least in a surface layer thereof. The porous portion has many fine voids. Due to the presence of the porous portion, the anode body has a fine uneven shape at least on the surface thereof to increase the surface area, thereby achieving a high capacity. The porous portion may be formed in a part of the surface layer of the anode body or may be formed in the entire surface layer. When the anode body is an anode foil, the porous portion may be formed, for example, at least in the surface layer of the cathode-forming portion or may be formed in at least a part of the surface layer of the anode leading portion in addition to the surface layer of the cathode-forming portion. When the anode body is a porous shaped body or a porous sintered body, the entire anode body may constitute the porous portion.

When the anode body is an anode foil, the porous portion is formed by roughening the surface of at least a part of a substrate (e.g., a metal foil) containing a valving metal, corresponding to the cathode-forming portion. Roughening may be performed by etching, for example. Etching may be electrolytic etching or chemical etching.

Usually, an anode body has six surfaces that define the outer shape of the anode body. Among these surfaces, a surface (usually a pair of surfaces) that occupies the largest area is referred to as a main surface, and surfaces other than the main surface are sometimes referred to as end surface. Corners are present between adjacent surfaces. For example, in a case in which the anode body is an anode foil, the anode body has a pair of main surfaces that occupy a large portion of the area of the anode foil, and end surfaces present between the pair of main surfaces.

In the present specification, a direction from the first end toward the second end of the anode body (e.g., an anode foil) where it is flat may be referred to as length direction of the anode body. The direction from the first end toward the second end is a direction parallel to a straight direction connecting the center of the end surface of the first end and the center of the end surface of the second end. This direction may be referred to as length direction of the anode body or the capacitor element. In addition, a direction perpendicular to the length direction and the thickness direction of the anode body (or the capacitor element) may be referred to as width direction of the anode body (or the capacitor element).

### (Dielectric Layer)

The dielectric layer is an insulative layer functioning as a dielectric. The dielectric layer is formed by anodizing the valving metal of the surface of the anode body, for example, by chemical conversion treatment. In the dielectric layer formed on the surface of an anode foil having a porous portion, the surface of the dielectric layer has a fine uneven shape according to the shape of the surface of the porous portion.

The dielectric layer may be formed of a material that functions as a dielectric layer. The dielectric layer contains, for example, an oxide of the valving metal as the material such as above. For example, a dielectric layer where tantalum is used as the valving metal contains Ta₂O₅, and a dielectric layer where aluminum is used as the valving metal contains Al₂O₃. However, the dielectric layer is not limited to these specific examples.

### (Cathode Portion)

The cathode portion includes at least a solid electrolyte layer covering at least a part of the dielectric layer. The solid electrolyte layer is formed on a part (in other words, a cathode-forming portion) of the anode body on the side of the second end with the dielectric layer therebetween. Usually, the cathode portion includes a solid electrolyte layer covering at least a part of the dielectric layer, and a cathode leading layer covering at least a part of the solid electrolyte layer. The solid electrolyte layer and the cathode leading layer will be described below.

### (Solid Electrolyte Layer)

The solid electrolyte layer contains a nitrogen element, a sulfur element, a carbon element, and an oxygen element. In the anode body covered with the dielectric layer, the solid electrolyte layer is divided into a first portion filled in the voids of the porous portion and a second portion protruding from the main surface of the anode body covered with the dielectric layer. A mass ratio: N/S of the nitrogen element to the sulfur element in the second portion is 0.30 or more and 1.00 or less. As a result of the N/S ratio being within such a range, an increase in ESR after the solid electrolytic capacitor is exposed to a high-temperature and high-humidity environment can be reduced.

The solid electrolyte layer is constituted of a solid electrolyte (in other words, a conductive polymer). The conductive polymer contains a conjugated polymer and a dopant. The conductive polymer may further contain an additive, as necessary. The solid electrolyte layer contains at least one selected from the group consisting of the component derived from the cationic agent and the component derived from the anionic agent as described above. The nitrogen element may be derived from the conjugated polymer, but the majority thereof is derived from the cationic agent contained in the treatment liquid. The sulfur element may be derived from the conjugated polymer or the dopant, but the majority thereof is derived from the anionic agent contained in the treatment liquid. Therefore, it can be said that the N/S ratio represents the balance between the cationic agent and the anionic agent in the second portion of the solid electrolyte layer. The nitrogen element and the sulfur element may be contained in the first portion. As a result of the N/S ratio of the second portion, which occupies a large portion of the solid electrolyte layer, being within the above-described range, a remarkable effect of suppressing an increase in ESR can be obtained.

The N/S ratio is 0.30 or more, and may be 0.35 or more, 0.40 or more, or 0.41 or more. The N/S ratio is 1.00 or less, and may be 0.97 or less or 0.95 or less. In view of keeping ESR further lower after the solid electrolytic capacitor is exposed to a high-temperature and high-humidity environment, the N/S ratio may be 0.80 or less, or 0.77 or less. The N/S ratio may be, for example, 0.30 or more and 1.00 or less, 0.35 or more and 0.97 or less, or 0.40 or more and 0.95 or less.

The carbon element and the oxygen element contained in the solid electrolyte layer are mostly derived from the conductive polymer. The N/(C+O+S) ratio may be 0.033 or more or 0.034 or more. The N/(C+O+S) ratio may be 0.035 or more in view of keeping ESR further lower after the solid electrolytic capacitor is exposed to a high-temperature and high-humidity environment. The N/(C+O+S) ratio may be 0.050 or less or 0.046 or less. The N/(C+O+S) ratio may be 0.033 or more and 0.050 or less, 0.034 or more and 0.050 or less, or 0.035 or more and 0.050 or less.

The mass-based content of each element in the second portion is determined by performing element mapping by energy dispersive X-ray spectroscopy (EDX) based on an image of the capacitor element or the solid electrolytic capacitor in which the second portion is exposed. Here, the image is captured using a scanning electron microscope (SEM). The N/S ratio and the N/(C+O+S) ratio can be obtained from the determined contents. The element mapping is performed on a rectangular region (region A) having a length of a first side of 10 μm or more and 20 μm or less and a length of a second side perpendicular to the first side of 12 μm or more and 25 μm or less. The first side of the region A may or may not be parallel to the width direction or the thickness direction of the capacitor element. The second side of the region A may or may not be parallel to the thickness direction or the width direction of the capacitor element. The shortest distance between the region A and the main surface of the anode body may be 0 μm or more and 5 μm or less. The shortest distance between the region A and the main surface of the anode body refers to the shortest distance between the region A and the average main surface of the anode body that is determined in the cross-sectional image. The content of each element is determined by measuring a plurality of regions A of the exposed cross section, followed by averaging the results. Preferably, the shortest distances between each of the respective regions A and the main surface of the anode body and the average of the shortest distances between the respective regions A and the main surface of the anode body both satisfy the above range.

A sample for SEM image capture can be prepared in the following manner. A capacitor element or a solid electrolytic capacitor is embedded in a curable resin, and the curable resin is cured. The resultant cured product is wet-polished or dry-polished to expose a cross section parallel to the thickness direction of the cathode portion (a cross section in which the stacked state of each layer of the cathode portion is recognizable). The exposed cross section is smoothed by ion milling to obtain a sample for image capture. Given that the length of the region in which the solid electrolyte layer is formed is 1 in the direction parallel to a length direction of the capacitor elements, the cross section is taken as a cross section at a position 0 to 0.05 (0 to 0.05 inclusive) apart from the end on the side of the first end of the region in which the solid electrolyte layer is formed.

The maximum thickness of the second portion may be 15 μm or more, or 16 μm or more. The maximum thickness of the second portion may be 42 μm or less, or 40 μm or less. The maximum thickness of the second portion may be, for example, 15 μm or more and 42 μm or less, or 16 μm or more and 42 μm or less. As a result of the maximum thickness of the second portion being within such a range, a part of the second portion on the side of the first portion can ensure a high degree of conductivity even when a part thereof on the side of the cathode leading layer degrades in a high-temperature and high-humidity environment, thereby achieving further suppression of an increase in ESR. The maximum thickness of the second portion is the maximum value of the thickness of the second portion determined in the cross-sectional image described above.

In a cross section of the solid electrolyte layer, taken at an arbitrary position of of a part of the solid electrolyte element on the side of the first end of the anode body, perpendicular to the direction from the first end to the second end of the capacitor element, the ratio: T1/T2 of the thickness T1 of the second portion at the corner of the anode body to the thickness T2 of the second portion at the central part of the anode body may be 0.8 or more, or may be 0.9 or more. The ratio: T1/T2 may be 1.7 or less, 1.5 or less, or 1.2 or less. The ratio: T1/T2 may be, for example, 0.8 or more and 1.7 or less, or 0.9 or more and 1.7 or less. As a result of the ratio T1/T2 being within such a range, spread in variation of conductivity of the solid electrolyte layer when the solid electrolyte layer is exposed to a high-temperature and high-humidity environment is suppressed to further suppress an increase in ESR. In addition, since the thickness of the solid electrolyte layer at the corners is suppressed from decreasing, occurrence of product defects due to a short circuit is suppressed.

### (First Portion)

The first portion includes at least a first conductive polymer layer and may include the first conductive polymer layer and a second conductive polymer layer. The first portion may be a single layer or may be constituted of multiple layers. When the first part is constituted of multiple layers, the kinds, compositions, contents, and the like of, for example, the conductive polymers and the additives contained in the respective layers may be the same or different. However, each of the first conductive polymer layer and the second conductive polymer layer is not necessarily a layer or does not have a layered structure. For example, the first conductive polymer layer may be in a state of a first conductive polymer attached to the surface of the dielectric layer.

Examples of the first conductive polymer and a second conductive polymer that are contained in the respective conductive polymer layers include known conductive polymers used for solid electrolytic capacitors, such as a conjugated polymer (e.g., π-conjugated polymer) and a dopant. The first conductive polymer may contain a self-doped conductive polymer.

Examples of the conjugated polymer include polymers with polypyrrole, polythiophene, polyaniline, polyfuran, polyacetylene, polyphenylene, polyphenylene vinylene, polyacene, or polythiophene vinylene as its basic backbone. The above polymers should contain at least one kind of monomer unit constituting the basic backbone. The monomer unit also includes a monomer unit having a substituent. Homopolymers and copolymers of two or more kinds of monomers are also included in the polymers. For example, polythiophene includes poly3,4-ethylenedioxythiophene (PEDOT).

When a conjugated polymer containing a monomer unit corresponding to a thiophene compound is used, the initial ESR can be low, and a high capacity can be easily obtained. Examples of the thiophene compound include compounds having a thiophene ring and capable of forming a repeating structure of the corresponding monomer unit. The thiophene compound can form a repeating structure of a monomer unit through connection at the second and fifth positions of the thiophene ring.

The thiophene compound may have a substituent at at least one of the third position and the fourth position of the thiophene ring, for example. The substituent at the third position and the substituent at the fourth position may be bonded to form a ring condensed to the thiophene ring. Examples of the thiophene compound include thiophenes that optionally have a substituent at at least one of the third position and the fourth position, and alkylenedioxythiophene compounds (e.g., C₂₋₄ alkylenedioxythiophene compounds such as an ethylenedioxythiophene compound). Compounds with a substituent at a position on an alkylene group are also included in the alkylenedioxythiophene compounds.

The substituent is preferably, but not limited to, an alkyl group (e.g., a C₁₋₄ alkyl group such as a methyl group or an ethyl group), an alkoxy group (e.g., a C₁₋₄ alkoxy group such as a methoxy group or an ethoxy group), a hydroxy group, or a hydroxyalkyl group (e.g., a hydroxy C₁₋₄ alkyl group such as a hydroxymethyl group), for example. When the thiophene compound has two or more substituents, the substituents may be the same as or different from each other.

A conjugated polymer (e.g., PEDOT) containing a monomer unit corresponding to at least a 3,4-ethylenedioxythiophene compound (e.g., 3,4-ethylenedioxythiophene (EDOT)) may be used. The conjugated polymer containing at least a monomer unit corresponding to EDOT may contain only a monomer unit corresponding to EDOT or may contain a monomer unit corresponding to a thiophene compound other than EDOT in addition to the monomer unit. One conjugated polymer may be used, or two or more conjugated polymers may be used in combination.

The weight average molecular weight (Mw) of the conjugated polymer is, but not particularly limited to, 1000 or more and 1,000,000 or less, for example.

In the present specification, the weight average molecular weight (Mw) is a value expressed in terms of polystyrene conversion measured by gel permeation chromatography (GPC). Usually, measurement by GPC uses a polystyrene gel column and water and methanol (volume ratio 8/2 (=water/methanol)) as a mobile phase.

As the dopant, at least one selected from the group consisting of an anion and a polyanion is used, for example.

Examples of the anion include, but are not particularly limited to, sulfate ion, nitrate ion, phosphate ion, borate ion, an organic sulfonate ion, and carboxylate ion. Examples of a sulfonate ion-generating dopant include aromatic sulfonic acid compounds (e.g., p-toluenesulfonic acid and naphthalenesulfonic acid).

Examples of the polyanion include a polymeric polysulfonic acids and polymeric polycarboxylic acids. Examples of the polymeric polysulfonic acids include polyvinylsulfonic acid, polystyrenesulfonic acid, polyallylsulfonic acid, polyacrylsulfonic acid, and poly(methacrylsulfonic acid). Examples of the polymeric polycarboxylic acids include polyacrylic acid and polymethacrylic acid. The polyanion also includes polyester sulfonic acids and phenol sulfonic acid novolac resins. However, the polyanion is not limited thereto.

From the viewpoint of easy suppression of dedoping, it is advantageous to use, among the pholyanions, a polyanion (e.g., a polymeric polysulfonic acid) having relatively high levels of heat resistance and electron withdrawing property.

The anionic group (e.g., a sulfo group or a carboxy group) of the dopant may be contained in the first portion in free form, in anionic form, or in salt form, or may be contained in a form bound to or interacting with the conjugated polymer. In the present specification, the groups in these forms may be referred to simply as, for example, “anionic group,” “sulfo group,” and “carboxy group.”

The amount of the dopant contained in the first conductive polymer layer or the second conductive polymer layer is, for example, 10 parts by mass or more and 1000 parts by mass or less and may be 50 parts by mass or more and 200 parts by mass or less, relative to 100 parts by mass of conjugated polymer.

Each of the first conductive polymer layer and the second conductive polymer layer may be formed by depositing a treatment liquid (e.g., a dispersion liquid or a solution) containing a conductive polymer (e.g., a conjugated polymer and a dopant) on the dielectric layer, followed by drying. Examples of the dispersion medium contained in the dispersion liquid (or solvent contained in the solution) include at least one selected from the group consisting of water and an organic solvent. The treatment liquid may further contain another component (e.g., an additive). For example, a treatment liquid containing a conductive polymer (e.g., PEDOT), a dopant (e.g., a polyanion such as polystyrene sulfonic acid), and, if necessary, an additive may be used to form the solid electrolyte layer.

The first conductive polymer layer may be formed by polymerizing a precursor of the conjugated polymer on the dielectric layer with a treatment liquid containing the precursor and a dopant. Polymerization can be performed by at least either chemical polymerization or electrolytic polymerization. Examples of the precursor of the conjugated polymer include monomers, oligomers, and prepolymers. When a treatment liquid containing a precursor of the conjugated polymer is used, an oxidizer is used for polymerizing the precursor. The oxidizer may be contained as an additive in the treatment liquid. The oxidizer may be applied to the anode body with the dielectric layer formed thereon before or after the treatment liquid is brought into contact with the anode body. Examples of such an oxidizer include compounds (e.g., ferric sulfate) capable of producing Fe³⁺, persulfates (e.g., sodium persulfate and ammonium persulfate), and hydrogen peroxide. One oxidizer may be used singly, or two or more oxidizers may be used in combination.

The treatment liquid for forming the first portion (e.g., the first conductive polymer layer) may be referred to as first treatment liquid. The step of forming the first conductive polymer layer by immersing in the first treatment liquid and polymerization (or drying) may be performed once or may be repeated multiple times. Similarly, the step of forming the second conductive polymer layer may be performed once or may be repeated multiple times. In multiple repetition, the conditions such as the composition and viscosity of the treatment liquid may be the same each time, or at least one of the conditions may be changed.

Each of the first conductive polymer layer and the second conductive polymer layer may be a single layer or may be constituted of multiple layers. When the first layer is constituted of multiple layers, the conductive polymers contained in the respective layers may be the same or different.

### (Second Portion)

The second portion contains a second conductive polymer (e.g., a conjugated polymer and a dopant), for example. The second potion may contain at least a second conductive polymer layer. The second portion (or the second conductive polymer layer) may be a single layer or may be constituted of multiple layers. When the second portion (or the second conductive polymer layer) is constituted of multiple layers, the types, compositions, contents, and the like of, for example, the conductive polymers and the additives contained in the respective layers may be the same or may be different.

As the second conductive polymer constituting the second portion or the second conductive polymer layer, the description of the second conductive polymer for the first portion can be referred to. The conjugated polymer contained in the second portion preferably contains a monomer unit corresponding to a thiophene compound. The dopant preferably has a sulfo group. As a result of the second portion containing the conjugated polymer and the dopant such as above, ESR can be kept further low by setting the N/S ratio within the above range.

The anionic group (e.g., a sulfo group or a carboxy group) of the dopant may be contained in the second portion in a free form, an anionic form, or a salt form, or may be contained in a form bound to or interacting with the conjugated polymer. In the present specification, the groups in these forms may be referred to simply as, for example, “anionic group,” “sulfo group,” and “carboxy group.”

The amount of the dopant contained in the second layer is, for example, 10 parts by mass or more and 1000 parts by mass or less relative to 100 parts by mass of the conjugated polymer and may be 50 parts by mass or more and 200 parts by mass or less.

The second portion (or the second conductive polymer layer) is formed, for example, by treatment on the anode body covered with the first portion (or the first conductive polymer layer) with the dielectric layer therebetween with a treatment liquid (second treatment liquid) containing an anionic agent and a cationic agent, or a salt thereof, followed by treatment on the anode body with a treatment liquid (third treatment liquid) containing the second conductive polymer. At least one of the anionic agent and the cationic agent contains a nitrogen element. At least one of the anionic agent and the cationic agent contains a sulfur element. The second treatment liquid may further contain a surface treatment agent.

More specifically, the second portion (or the second conductive polymer layer) is formed by treating the anode body with the second treatment liquid, drying, treating with the third treatment liquid, and then drying. Step A of performing the treatment with the second treatment liquid and drying and Step B of performing the treatment with the third treatment liquid and drying may be repeated multiple times. The pattern (e.g., a repetitive pattern) in which Step A and Step B are performed may be determined according to the N/S ratio or the N/(C+O+S) ratio. For example, Step A and Step B may be alternately repeated. Alternatively, Step A may be performed once or multiple times, followed by Step B performed once or multiple times. It is also possible that Step A is performed multiple times, followed by Step B multiple times, and these are alternately repeated. In Step A, after the treatment with the second treatment liquid and the drying, washing with water and drying may be performed.

Each of the N/S ratio and the N/(C+O+S) ratio can be adjusted, for example, by selecting or adjusting at least one selected from the group consisting of use of a surface treatment agent, the concentration of the surface treatment agent in the second treatment liquid, the concentration of the anionic agent, the cationic agent, or the salt thereof in the second treatment liquid, the respective numbers of times of Step A and Step B, performance of water washing in Step A, and the repetitive pattern of Step A and Step B. In addition to the above, the N/(C+0+S) ratio may be adjusted, for example, according to the type of the second conductive polymer and the quantitative ratio of the dopant to the conjugated polymer. Also, the maximum thickness of the second portion can be adjusted, for example, by selecting or adjusting at least one selected from the concentration of the anionic agent, the cationic agent or the salt thereof in the second treatment liquid, the respective numbers of times of Step A and Step B, and performance of water washing in Step A. The T1/T2 ratio can be adjusted, for example, by adjusting the kind and concentration of the surface treatment agent, the kind of the liquid medium used for the second treatment liquid, and drying conditions of the coated film of the second treatment liquid.

Each of the cationic agent and the anionic agent is different from the surface treatment agent. Examples of the surface treatment agent include surfactants. A component which is not a surfactant is used as the cationic agent or the anionic agent.

Usually, each of the first conductive polymer layer and a layer formed with the third treatment liquid contains an anionic dopant, and this dopant is likely to be present on the surface of each layer. That is, since the surface of each layer is likely to be negatively charged, it is difficult to form a layer containing the second conductive polymer on each layer. By applying the second treatment liquid containing a cationic agent to the first conductive polymer layer or the layer formed with the third treatment liquid, film formability of the second conductive polymer layer can be enhanced. In addition, as a result of the second treatment liquid containing an anionic agent, dissociation ability of the cationic agent can be enhanced while the coating self-repairability of the dielectric layer can be enhanced, which is advantageous in enhancing film formability.

### (Cationic Agent)

The cationic agent, which has a cationic group, is not particularly limited as long as it is capable of forming a cation in a dissociated state. The cationic agent may be, for example, a metal compound (e.g., an inorganic base such as a metal hydroxide), but an organic compound (e.g., an organic base) containing a nitrogen element is preferable. As the cationic group of the cationic agent being an organic compound, an amino group (e.g., a primary amino group, a secondary amino group, or a tertiary amino group) or a quaternary ammonium group is preferable. For example, salts of amino groups and salts of quaternary ammonium groups are included in the cationic group such as above. The second portion or the second conductive polymer layer may contain one cationic agent or may contain two or more cationic agents.

Among the cationic agents, a cationic agent (e.g., an amine compound) having an amino group as a cationic group is preferable. Examples of the amine compound include amines (e.g., primary amines, secondary amines, and tertiary amines) having 1 or more and 3 or less substituents on a nitrogen atom, and diamines optionally having 1 or 2 alkyl groups on a nitrogen atom. The substituent is selected from the group consisting of, for example, an alkyl group, a cycloalkyl group, and an aryl group. Each of the alkyl group, the cycloalkyl group, and the aryl group may further have a substituent (e.g., at least one selected from the group consisting of a hydroxy group and an alkoxy group).

Examples of the diamine include diaminoalkanes, diaminocycloalkanes (e.g., diamino C₅₋₈ cycloalkanes such as diaminocyclohexane) and diaminoarenes (e.g., diamino C₆₋₁₄ arenes such as diaminobenzene and diaminonaphthalene). Examples of the diaminoalkanes include diamino C₂₋₁₄ alkanes and diamino C₄₋₁₂ alkanes. Specific examples of the diaminoalkanes include 1,4-diaminobutane, 1,6-diaminohexane, 1,8-diaminooctane, and 1,10-diaminodecane.

As an amine, at least one selected from the group consisting of a primary amine and a tertiary amine may be used. Examples of the tertiary amine include N,N-di-C₁₋₁₀alkyl-N—C₄₋₁₆ alkyl-amines (e.g., N,N-dimethylhexylamine, N,N-dimethyloctylamine, and N,N-diethyloctylamine), N,N-di-C₄₋₁₆alkyl-N—C₁₋₁₀alkyl-amines, and tri-C₄₋₁₆alkyl-amines.

The second portion or the second conductive polymer layer may contain a cationic agent in any form among an amine compound, a cation corresponding to the amine compound, a quaternary ammonium compound, and a salt of the cation. For example, the cationic agent may form a salt with the anionic agent or may interact with the dopant in the second portion or the second conductive polymer layer.

### (Anionic Agent)

As the anionic agent, at least one selected from the group consisting of the anions and polyanions exemplified as the dopant of the first conductive polymer and the second conductive polymer may be used, for example. In particular, it is preferable to use an anionic agent containing a sulfur element. From the viewpoint of suppressing dedoping from the first conductive polymer and the second conductive polymer, a dopant different from the dopant of the first conductive polymer and the dopant of the second conductive polymer is preferably used as the anionic agent. From the same viewpoint as above, an anionic agent having an electron withdrawing property lower than that of the dopant of each conductive polymer may be used as the anionic agent.

In the second treatment liquid, the anionic group of the anionic agent may be contained in any form selected from the anionic groups described above, anions corresponding to the anionic groups described above, and salts of the anions.

As the anionic agent, a sulfonic acid compound (e.g., aliphatic sulfonic acid, alicyclic sulfonic acid, or aromatic sulfonic acid) may be used, for example.

In view of suppressing corrosion of the valving metal constituting the anode body, an anionic agent (first anionic agent) having a sulfo group (first anionic group) and a second anionic group having an electron withdrawing property lower than that of the sulfo group may be used. Examples of the first anionic agent include anionic agents having a sulfo group and a carboxy group, and anionic agents having a sulfo group and a hydroxy group. Examples of the first anionic agent include aliphatic compounds (e.g., sulfosuccinic acid) and aromatic compounds (e.g., sulfobenzoic acid, sulfosalicylic acid, disulfosalicylic acid, sulfophthalic acid, sulfoisophthalic acid, sulfoterephthalic acid, and naphthosulfonic acid). As the first anionic agent, a polymer having a sulfo group and a second anionic group may be used.

Examples of the first anionic agent being a polymer (polymer compound) include copolymers (p1) containing at least a monomer unit having a first anionic group and a monomer unit having a second anionic group, and polymers (p2) containing at least a monomer unit having a first anionic group and a second anionic group. These polymers may further include another copolymerizable monomer unit.

Examples of a monomer unit on which the above monomer units are based include aliphatic vinyl monomer units such as ethylene and propylene, aromatic vinyl monomer units such as styrene, and diene monomer units such as butadiene and isoprene.

The Mw of the polymer is, for example, 5000 or more and 500,000 or less, and may be 10,000 or more and 200,000 or less.

One first anionic agent may be used singly, or two or more first anionic agents may be used in combination.

The first anionic agent may be used in combination with a second anionic agent, as necessary. As the second anionic agent, a monomer compound among the anions and polyanions listed as the dopant for the first layer may be used, for example. The second anionic agent may be any of an aliphatic compound, an alicyclic compound, and an aromatic compound. As the second anionic agent, one anionic agent may be used singly, or two or more anionic agents may be used in combination.

Examples of the second anionic agent include the aforementioned sulfonic acid compounds, carboxylic acid acid-phosphooxy polyoxyalkylene glycol monoacrylate (acid-phosphooxy polyoxyethylene glycol mono(meth)acrylate (P(═O)(OH)₂—(O—CH₂CH₂)ₙ—O—C(═O)—CR—CH₂), where n represents an integer of 2 or more and 10 or less, and R represents either a hydrogen atom or a methyl group), such as acid-phosphooxyethyl acrylate and acid-phosphooxyethyl methacrylate, aliphatic phosphonic acids (e.g., vinylphosphonic acid), aromatic phosphonic acids (e.g., phenylphosphonic acid), carboxylic acids [aliphatic carboxylic acids (e.g., C₂₋₁₀ alkanecarboxylic acids such as propanoic acid, butanoic acid, and hexanoic acid, and C₄₋₁₂ alkanedicarboxylic acids such as hexanedioic acid), alicyclic carboxylic acids (e.g., carboxy C₅₋₈ cycloalkanes such as carboxycyclohexane, and dicarboxy C₅₋₈ cycloalkanes such as cyclohexanedicarboxylic acid), and aromatic carboxylic acids (e.g., carboxy C₆₋₁₄ arene such as benzoic acid, carboxyhydroxy C₆₋₁₄ arene such as salicylic acid, and dicarboxy C₆₋₁₄ arene such as phthalic acid, isophthalic acid, terephthalic acid, and naphthalenedicarboxylic acid)], phenolic compounds (e.g., phenol, hydroxytoluene, vinylphenol, and hydroxyvinyltoluene), and hydroxyalkyl esters of the above-mentioned carboxylic acids (e.g., hydroxy C₁₋₄ alkyl esters such as hydroxyethyl acrylate and hydroxyethyl methacrylate). Examples of the sulfonic acid compounds include aliphatic sulfonic acids (e.g., C₁₋₆ alkanesulfonic acids such as methanesulfonic acid), alicyclic sulfonic acids (e.g., C₅₋₈ cycloalkanesulfonic acids such as cyclohexanesulfonic acid), and aromatic sulfonic acids (e.g., C₆₋₁₄ arenesulfonic acids such as benzenesulfonic acid and styrenesulfonic acid).

As the second anionic agent, one having two or more anionic groups may be used. Examples of such a second anionic agent include second anionic agents having a phosphate group and a carboxy group (e.g., 2-(dihydroxyphosphinyloxy)acrylic acid), and second anionic agents having a phosphonic acid group and a carboxy group (e.g., phosphonoacrylic acid and 2-methyl-3-phosphonoacrylic acid).

### (Surface Treatment Agent)

The surface treatment agent includes a leveling agent and an antifoaming agent, for example. In view of spreading the second treatment liquid containing the surface treatment agent over the entire surface of the cathode-forming portion of the anode body, the surface treatment agent preferably has a leveling action. As the surface treatment agent, a surfactant is preferably used.

The surfactant may be either a nonionic surfactant or an ionic surfactant. The surfactant has a hydrophilic group and a hydrophobic group. The ionic surfactant includes cationic surfactants, anionic surfactants, and amphoteric surfactants. One surfactant may be used singly, or two or more surfactants may be used in combination.

Examples of the nonionic surfactant include nonionic surfactants of ether types (e.g., polyether type), ester-ether type (e.g., fatty acid polyethylene glycol and fatty acid polyoxyethylene sorbitan), ester type (e.g., glycerol fatty acid ester, sorbitan fatty acid ester, and sucrose fatty acid ester), and alkanolamide type (e.g., fatty acid alkanolamide). Examples of the nonionic surfactants of polyether type include those having a polyoxyalkylene chain such as a polyoxyethylene chain (e.g., polyoxyethylene alkyl ether, polyoxyethylene alkyl phenyl ether, and polyoxyethylene polyoxypropylene glycol). The nonionic surfactant may be one having a halogen atom. Examples of the halogen atom include a fluorine atom, chlorine atom, a bromine atom, and an iodine atom. Among them, a fluorine atom is preferable.

Examples of the cationic surfactant include cationic surfactants of alkylamine salt type (e.g., monoalkylamine salt, dialkylamine salt, and trialkylamine salt), and quaternary ammonium salt type (e.g., halogenated alkyltrimethylammonium, halogenated dialkyldimethylammonium, and alkylbenzalkonium chloride).

Examples of the anionic surfactant include anionic surfactants of carboxylate type, sulfonate type, sulfate ester type, and phosphate ester type. Examples of the anionic surfactants of carboxylate type include aliphatic monocarboxylate salts, polyoxyethylene alkyl ether carboxylate salts, N-acyl sarcosinate salts, and N-acyl glutamate salts. Examples of the anionic surfactants of sulfonate type include dialkyl sulfosuccinate salts, alkane sulfonate salts, α-olefin sulfonate salts, alkyl benzene sulfonate salts, naphthalene sulfonate-formaldehyde condensates, alkyl naphthalene sulfonate salts, and N-methyl-N-acyltaurine salts. Examples of the anionic surfactants of sulfate ester type include alkyl sulfurate salts, polyoxyethylene alkyl ether sulfate salts and oil/fat sulfate ester salts. Examples of the anionic surfactants of phosphate ester type include alkyl phosphate salts, polyoxyethylene alkyl ether phosphate salts, and polyoxyethylene alkyl phenyl ether phosphate salts.

Examples of the amphoteric surfactants include amphoteric surfactants of carboxybetaine type (e.g., alkylbetaine and fatty acid amidopropylbetaine), 2-alkylimidazoline derivative type (e.g., 2-alkyl-N-carboxymethyl-N-hydroxyethylimidazolium betaine), glycine type (e.g., alkyl diethylenetriamine acetic acid and dialkyl diethylenetriamine acetic acid), amine oxide type (e.g., alkylamine oxide).

When a nonionic surfactant is used, the pot life of the second treatment liquid can be inhibited from shortening, and dedoping of the conductive polymer can be suppressed. A cationic surfactant or an amphoteric surfactant may be used from the viewpoint of facilitating attachment of the conductive polymer to the surface of the anode body. From the viewpoint of easily suppressing volatilization of the later-described cationic agent, an anionic surfactant may be used.

The content of the surface treatment agent in the second portion may be 0.01% by mass or more and 30% by mass or less or may be 0.10% by mass or more and 15% by mass or less. As a result of the content of the surface treatment agent being within such a range, the surface treatment agent can be more uniformly distributed over the entire surface of the cathode-forming portion, variation in thickness of the second portion can be easily reduced, and the intrinsic resistance of the second portion can be kept low, which is advantageous in suppressing an increase in ESR.

### (Others)

Each of the first portion and the second portion may further contain at least one selected from the group consisting of a known additive and a known conductive material other than the conductive polymers, as necessary. Examples of the conductive material include at least one selected from the group consisting of a conductive inorganic material such as manganese dioxide, and a TCNQ complex salt. A layer for enhancing adhesion may be provided between the dielectric layer and the first portion (or the first conductive polymer layer).

### (Cathode Leading Layer)

The cathode leading layer should include at least a first layer that is in contact with the solid electrolyte layer and that covers at least a part of the solid electrolyte layer and may include a second layer covering at least a part of the first layer in addition to the first layer.

Examples of the first layer include a metal foil and a layer containing conductive particles. Examples of the conductive particles include at least one selected from conductive carbon and metal powder. The cathode portion (more specifically, the cathode leading layer) may include a layer (e.g., a metal particle-containing layer) containing metal powder. In this case, the intrinsic resistance of the cathode leading layer (e.g., the metal particle-containing layer) tends to increase in a high-temperature and high-humidity environment due to the presence of a component derived from the anionic agent. In the present disclosure, since the N/S ratio of the second portion is set within the specified range, high conductivity of the cathode leading layer (e.g., the metal particle-containing layer) can be ensured, and an increase in ESR in a high-temperature and high-humidity environment can be suppressed. The cathode leading layer may be constituted of, for example, a layer (carbon layer) containing conductive carbon as the first layer and a metal foil or a layer (e.g., the metal particle-containing layer) containing metal powder as the second layer.

When the cathode leading layer includes a metal foil or a metal particle-containing layer, the entire cathode leading layer may be constituted of the metal foil or the metal particle-containing layer. Alternatively, at least one of the first layer and the second layer may be constituted of a metal particle-containing layer.

Examples of the conductive carbon include graphite (e.g., artificial graphite and natural graphite).

The layer containing a metal powder as the second layer can be formed, for example, by stacking a composition containing the metal powder on the surface of the first layer. One example of such a second layer may be a metal particle-containing layer formed with a paste containing a metal powder and a resin binder. As the resin binder, a thermoplastic resin can be used, but a thermosetting resin such as an imide-based resin or an epoxy resin is preferably used. From the viewpoint of easily obtaining a high conductivity of the second layer, a silver-containing particles may be used as the metal powder. Examples of the silver-containing particles include silver particles and silver-alloy particles. The second layer may contain one kind of silver-containing particles or may contain two or more kinds of silver-containing particles in combination. The silver particles may contain a small amount of impurity.

When a metal foil is used as the first layer, the kind of metal is not particularly limited. As the metal foil, it is preferable to use a valving metal (e.g., aluminum, tantalum, or niobium) or an alloy containing a valving metal. If necessary, the surface of the metal foil may be roughened. On the surface of the metal foil, a chemical conversion coating may be provided or a coating of a non-metal or a metal (dissimilar metal) different from the metal constituting the metal foil may be provided. Examples of the dissimilar metal and the non-metal include metals such as titanium and non-metals such as carbon (e.g., conductive carbon).

The metal foil may serve as the second layer, while the coating of a dissimilar metal or a non-metal (e.g., conductive carbon) forms the first layer.

The cathode leading layer is formed by a known method according to the layer structure. For example, when the cathode leading layer includes a metal foil as the first layer or the second layer, the first layer or the second layer is formed by stacking the metal foil so as to cover at least a part of the solid electrolyte layer or the first layer. A first layer containing conductive particles is formed, for example, by applying a conductive paste or a liquid dispersion containing the conductive particles and, if necessary, a resin binder (e.g., a water-soluble resin or a curable resin) to the surface of the solid electrolyte layer. A second layer containing a metal powder is formed, for example, by applying a paste containing the metal powder and a resin binder to the surface of the first layer. In the process of forming the cathode leading layer, drying, heating, or the like may be performed, as necessary.

### (Separator)

When a metal foil is used as the cathode leading layer, a separator may be provided between the metal foil and the anode foil. The separator is not particularly limited, and for example, a nonwoven fabric containing fibers of cellulose, polyethylene terephthalate, vinylon, or polyamide (e.g., aliphatic polyamide or aromatic polyamide such as aramid) may be used.

### (Others)

The solid electrolytic capacitor includes at least one capacitor element. The solid electrolytic capacitor may be of wound type or may be of either chip type or stacked type. For example, the solid electrolytic capacitor may include a plurality of stacked capacitor elements. The solid electrolytic capacitor may include two or more wound capacitor elements. The configuration of the capacitor element should be selected according to the type of the solid electrolytic capacitor.

In the capacitor element, the cathode lead terminal may be electrically connected to one end of the cathode leading layer. The cathode lead terminal is bonded to the cathode lead terminal, for example, by means of a conductive adhesive applied to the cathode leading layer. One end of the anode lead terminal may be electrically connected to the anode leading portion of the anode body. The other end of the anode lead terminal and the other end of the cathode lead terminal are led out of the resin outer housing or the case. The other ends of the terminals exposed from the resin outer housing or the case are used, for example, for soldering to a substrate on which the solid electrolytic capacitor is to be mounted. Alternatively, electrical connection to an external electrode may be established by exposing at least one of the end surfaces of the anode portion and the cathode portion from the outer surface of the sealing body, rather than by leading out the lead terminals.

The capacitor element is sealed with the resin outer housing or the case. For example, it is possible that the capacitor element and a material resin (e.g., an uncured thermosetting resin and a filler) for the outer housing resin are accommodated in a mold, and the capacitor element is sealed in the resin outer housing by transfer molding, compression molding method, or the like. In doing so, parts of the other ends of the anode lead terminal and the cathode lead terminal connected to the anode lead led from the capacitor element are exposed from the mold. Alternatively, the solid electrolytic capacitor may be formed in a manner that the capacitor element is housed in a bottomed case such that parts of the other ends of the anode lead terminal and the cathode lead terminal are located on the opening side of the bottomed case, and the opening of the bottomed case is sealed with a sealing body.

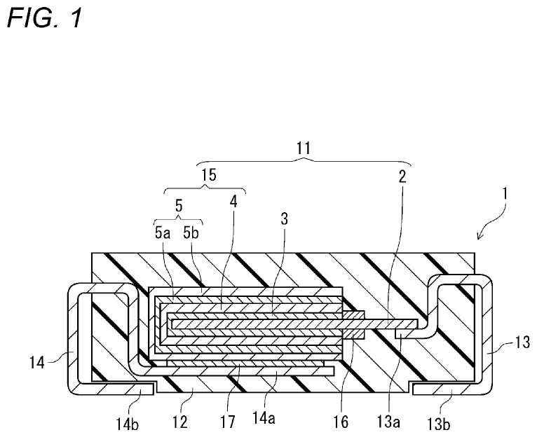

FIG. 1 is a schematic cross-sectional view of an electrolytic capacitor according to an embodiment of the present disclosure. A solid electrolytic capacitor 1 includes a capacitor element 11, a resin outer housing 12 that seals the capacitor element 11, and an anode terminal 13 and a cathode terminal 14 that are each exposed to the outside of the resin outer housing 12. The capacitor element 11 includes an anode body 2, a dielectric layer 3 covering a part of the anode body 2 on the side of the second end, and a cathode portion 15 covering the dielectric layer 3. A part of the anode body 2 where the cathode portion 15 (particularly, a solid electrolyte layer 4) is formed is a cathode-forming portion, and a part thereof where the cathode portion 15 is not formed is an anode leading portion. The anode terminal 13 is electrically connected to the anode leading portion of the anode body 2. The cathode terminal 14 is electrically connected to the cathode portion 15. The resin outer housing 12 has a substantially rectangular prism shape, whereby the solid electrolytic capacitor 1 also has a substantially rectangular prism shape.

The anode body 2 and the cathode portion 15 face each other with the dielectric layer 3 therebetween. The cathode portion 15 includes a solid electrolyte layer 4 covering the dielectric layer 3 and a cathode leading layer 5 covering the solid electrolyte layer 4. The cathode leading layer 5 in the illustrated example has a two-layer structure and includes a carbon layer 5a in contact with the solid electrolyte layer 4, and a metal particle-containing layer 5b covering the surface of the carbon layer 5a.

A separation part 16 that is insulative is formed on a region of the anode leading portion of the anode body 2 on the side of the cathode portion 15 so as to cover the surface of the anode body 2 in a belt-like manner. Here, the region of the anode leading portion is an area of the anode body 2 protruding from the cathode portion 15. The separation part 16 restricts contact between the cathode portion 15 and the anode body 2. The first end of the anode body 2 protruding from the cathode portion 15 is electrically connected to one end 13a of the anode terminal 13, for example, by welding. By contrast, the cathode leading layer 5 formed as the outermost layer of the cathode portion 15 is electrically connected to one end 14a of the cathode terminal 14 by means of a conductive adhesive 17 (e.g., a mixture of a thermosetting resin and metal particles). Another end 13b of the anode terminal 13 and another other end 14b of the cathode terminal 14 are led out of different side surfaces of the resin outer housing 12 and extend to one main flat surface (lower surface in FIG. 1) in an exposed manner. The exposed parts of the terminals on the flat surface are used, for example, for soldering to a substrate (not shown) on which the solid electrolytic capacitor 1 is to be mounted.

The dielectric layer 3 is formed on a part of the surface of the conductive material constituting the anode body 2. Specifically, the dielectric layer 3 can be formed by anodizing the surface of the conductive material constituting the anode body 2. As such, the dielectric layer 3 is formed along the surface of the anode body 2 (including the inner wall surface of pores and recesses positioned further inside the surface).

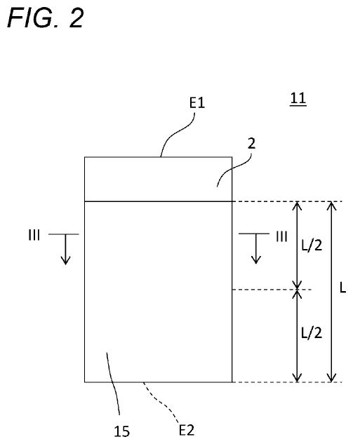

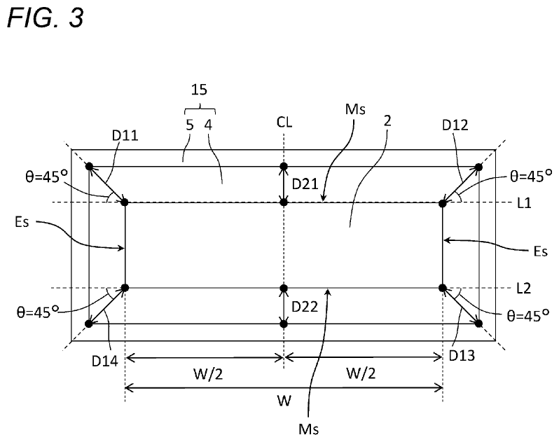

FIG. 2 is a schematic front view of the capacitor element 11 as viewed from the side of one of the main surfaces. FIG. 3 is a schematic cross-sectional view of a section (cross section G) of the capacitor element 11 of FIG. 2 taken along a line III-III, as viewed in the direction indicated by the arrow. Thicknesses T1 and T2 in the electrolyte layer are determined in the following manner, for example.

The ratio T1/T2 is determined in the cross section G of the cathode portion 15 perpendicular to a direction from a first end E1 to a second end E2 of the capacitor element 11 (which may be referred to as length direction of the anode body 2 or the capacitor element 11). Here, the cross section G is taken at an arbitrary position of a part of the cathode portion 15 on the side of the first end E1. The part of the cathode portion 15 on the side of the first end E1 is a part of the cathode portion 15 extending from the end on the side of the first end E1 to a position of the cathode portion 15 within a length L/2, where L represents the length of the cathode portion 15 in the length direction of the capacitor element 11. In FIG. 2, the part of the cathode portion 15 on the side of the first end E1 corresponds to an upper half part of the cathode portion 15.

FIG. 3 illustrates the cross section G of the capacitor element 11 taken along the line III-III at a part of the cathode portion 15 on the side of the first end E1, perpendicular to the length direction of the capacitor element 11. The line III-III corresponds to an arbitrarily selected position of the part of the cathode portion 15 on the side of the first end E1. In FIG. 3, hatching indicating a cross section is omitted.

The cross section G indicates a pair of main surfaces Ms of the anode body 2, which is an anode foil, and a pair of end surfaces Es located at the ends of the paired main surfaces Ms. Since there is a corner between each main surface Ms and each end surface Es, four corners can be recognized in the cross section G of the anode body 2. Imaginary straight lines L1 and L2 are drawn by extending lines corresponding to the main surfaces Ms outward, and a straight line passing through the apex of each corner is drawn at an angle of 45° relative to the straight line L1 or L2. Let the respective thicknesses of the solid electrolyte layer 4 at the corners be distances D11, D12, D13 and D14 between the points where the straight lines intersect the outer periphery of the solid electrolyte layer 4 and the apexes of the corners. T1 can be determined by averaging the values of these four distances.

In the cross section G, given that W represents the width of the anode body 2 corresponding to the length of the line segment corresponding to each main surface Ms, a center line CL is drawn at a position W/2 from the respective end surfaces Es. The center line CL passes through the midpoints of the line segments corresponding to the main surfaces Ms of the anode body 2. Distances D21 and D22 between the intersections of the center line CL and the outer periphery of the solid electrolyte layer 4 and the midpoints of the line segments are the thicknesses of the solid electrolyte layer at the central part of the main surfaces Ms. T2 can be determined by averaging the values of these two distances.

### Examples

The present invention will be specifically described below based on examples and comparative examples. However, the present invention is not limited to the following examples.

### <<Solid Electrolytic Capacitor E1>>

A solid electrolytic capacitor was produced in the following manner and the characteristics thereof were evaluated.

### (1) Anode Body Preparation Step

An anode body was produced by roughening both surfaces of an aluminum foil (thickness: 100 μm) as a substrate by etching.

### (2) Dielectric Layer Formation Step

A part of the anode body on the first end side was immersed in a chemical conversion liquid and a DC voltage at 70 V was applied for 20 minutes to form a dielectric layer containing aluminum oxide.

### (3) Solid Electrolyte Layer Formation Step

Chemical oxidative polymerization was performed by adding 3,4-ethylenedioxythiophene monomer to an aqueous solution of polystyrene sulfonic acid (Mw: 75,000) under stirring and then adding an oxidizer (ferric sulfate and sodium persulfate). The resulting polymerized liquid was filtered using an ion-exchanger to remove impurities, thereby obtaining a solution containing PEDOT as a first conductive polymer and polystyrene sulfonic acid (PSS) as a dopant.

Pure water was added to the obtained solution. The resulting solution was homogenized using a high-pressure homogenizer, and filtered using a filter to prepare a first treatment liquid in a dispersion state.

The anode body on which the dielectric layer in (2) above has been formed was immersed in the first treatment liquid, taken out of the first treatment liquid, and dried at 120° C. for a time of 10 minutes or more and 30 minutes or less. A first conductive polymer layer was formed so as to cover the surface of the dielectric layer 3 by repeating once more the immersion in the first treatment liquid and the drying.

A second treatment liquid was prepared by dissolving an ester-type nonionic surfactant (surface treatment agent) and a salt of a cationic agent (N,N-dimethyloctylamine) and an anionic agent (sulfoisophthalic acid) in distilled water. The amount of the surface treatment agent in the second treatment liquid was 0.5% by mass, and the concentration of the salt was 2.5% by mass. The anode body with the first layer formed thereon was immersed in the second treatment liquid, taken out, and dried at 100° C. for 3 minutes. Next, the dried anode body was immersed in a third treatment liquid having the same composition as that of the first treatment liquid, taken out, and dried at 120° C. for a time of 10 minutes or more and 30 minutes or less. The immersion in the second treatment liquid followed by the drying and the immersion in the third treatment liquid followed by the drying were alternately repeated four times. In the manner described above, a second conductive polymer layer containing a nitrogen element and a sulfur element was formed. It should be noted that most of the second portion is constituted of the second conductive polymer layer. Thus, a solid electrolyte layer including the first conductive polymer layer and the second conductive polymer layer (or the first portion and the second portion) was formed so as to cover the dielectric layer.

### (4) Cathode Leading Layer Formation Step

The anode body obtained in (3) above was immersed in a dispersion liquid of graphite particles dispersed in water, taken out of the dispersion liquid, and dried, thereby forming a carbon layer 5a on the surface of the solid electrolyte layer. The drying was performed at a temperature of 130° C. or higher and 180° C. or lower for a time of 10 minutes or longer and 30 minutes or shorter.

Next, a silver paste containing silver particles and a binder resin (epoxy resin) was applied to the surface of the carbon layer 5a, and heated at a temperature of 150° C. or higher and 200° C. or lower for a time of 10 minutes or longer and 60 minutes or shorter to cure the binder resin, thereby forming a metal particle-containing layer 5b. Thus, a cathode leading layer 5 composed of the carbon layer 5a and the metal particle-containing layer 5b was formed.

In the manner described above, the capacitor element 11 was produced.

### (5) Solid Electrolytic Capacitor Assembly

The cathode leading layer 5 of the capacitor element 11 obtained in (4) above and one end 14a of a cathode terminal 14 were bonded by means of a conductive adhesive 17. A part of the anode body 2 on the first end side protruding from the capacitor element 11 and the one end 13a of the anode terminal 13 were bonded by laser-welding.

Next, a resin outer housing 12 made of insulative resin was formed around the capacitor element 11 by transfer molding. In doing so, the other end 13b of the anode terminal 13 and the other end 14b of the cathode terminal 14 were led out from the resin outer housing 12.

A solid electrolytic capacitor E1 was thus completed. A total of 20 solid electrolytic capacitors E1 were produced in the same manner as described above.

### (6) Evaluation

Using each of the produced solid electrolytic capacitors, the following evaluations were performed.

### (a) Element Ratio of Second Portion

Element mapping by EDX was performed on the second portion in a SEM image of a cross section of the solid electrolytic capacitor according to the above-described manner to determine the mass rates of the nitrogen element, the sulfur element, the carbon element, and the oxygen element. The N/S ratio and the N/(C+O+S) ratio were determined from the mass rates of the elements.

The elemental mapping by EDX was performed under the conditions of 128 frames and a resolution of 256×200.

### (b) Maximum Thickness and Thickness Ratio T1/T2 of Second Portion

According to the above-described manner, the maxima of the thicknesses of the second portions of the respective solid electrolytic capacitors and the thickness ratios T1/T2 for the second portions were determined. Then, respective averages were calculated for the 20 solid electrolytic capacitors.

### (c) ESR

Each of the solid electrolytic capacitors was exposed to a high-temperature and high-humidity environment, and then ESR was measured. More specifically, the solid electrolytic capacitor was left to stand in a thermostat set at 85° C. and 85% RH for 1000 hours (high-temperature and high-humidity test). The solid electrolytic capacitor taken out of the thermostat was cooled to 20° C. Next, an ESR (mΩ) of the solid electrolytic capacitor at a frequency of 100 kHz was measured using an LCR meter for four-terminal measurements in an environment at 20° C. An average value was then calculated for the 20 solid electrolytic capacitors.

### <<Solid Electrolytic Capacitors E2 and E3>>

A total of 20 solid electrolytic capacitors of each type, E2 and E3, were produced and evaluated according to the procedure of the solid electrolytic capacitors E1. However, each anode body with the first layer formed thereon was immersed in the second treatment liquid, taken out, dried at 100° C. for 3 minutes, water washed by immersion in distilled water for 5 minutes, and dried at 100° C. for 3 minutes. Next, the dried anode body was immersed in the third treatment liquid having the same composition as that of the first treatment liquid, taken out, and dried at 120° C. for a time of 10 minutes or more and 30 minutes or less. The immersion in the second treatment liquid followed by the drying, the water washing followed by the drying, and the immersion in the third treatment liquid followed by the drying were repeated four times in this order. In the solid electrolytic capacitors E2, the concentration of the salt in the second treatment liquid was 3.8% by mass.

### <<Solid Electrolytic Capacitors E4 to E6>>

A total of 20 solid electrolytic capacitors of each type, E4, E5 and E6, were produced and evaluated according to the procedure of the solid electrolytic capacitors E1. However, the number of times the immersion in the second treatment liquid followed by the drying and the immersion in the third treatment liquid followed by the drying were alternately repeated was 4 for E4, 3 for E5, and 2 for E6. The concentration of the salt in the second treatment liquid was 3.8% by mass for E4 and 7.5% by mass for E5 and E6.

### <<Solid Electrolytic Capacitors C1 and C2>>

A total of 20 solid electrolytic capacitors of each type, C1 and C2, were produced and evaluated according to the procedure of the solid electrolytic capacitors E6. However, in production of C1 and C2, no surface treatment agent was used in preparation of the second treatment liquid. In addition, the number of times the immersion in the second treatment liquid followed by the drying, the water washing followed by the drying, and the immersion in the third treatment liquid followed by the drying were alternately repeated was 2 for C1 and 4 or C2.

Table 1 shows the results for the solid electrolytic capacitors E1 to E6 and C1 and C2. E1 to E6 are Examples, and C1 to C2 are Comparative Examples. Evaluation of ESR after the high-temperature and high-humidity test was expressed in terms of relative value when the measured value for the solid electrolytic capacitors C2 was taken as 100.

TABLE 1

| | N/S | | Maximum | | ESR after |
|---|---|---|---|---|---|
| | ratio | N/(C + O + S) | thickness | | high-temperature |
| | (mass | ratio | of second | T1/T2 | and high-humidity |
| | ratio) | (mass ratio) | portion (μm) | ratio | test |
| E1 | 0.61 | 0.042 | 25 | 1.0 | 13.0 |
| E2 | 0.58 | 0.041 | 40 | 0.9 | 13.7 |
| E3 | 0.41 | 0.035 | 27 | 1.0 | 24.4 |
| E4 | 0.77 | 0.046 | 35 | 1.1 | 22.1 |
| E5 | 0.95 | 0.034 | 26 | 1.0 | 37.1 |
| E6 | 0.41 | 0.042 | 16 | 0.9 | 41.8 |
| C1 | 0.29 | 0.031 | 14 | 0.7 | 77.2 |
| C2 | 1.05 | 0.018 | 52 | 0.5 | 100.0 |

As shown in Table 1, an increase in ESR after the high-temperature and high-humidity test was remarkably suppressed in E1 to E6 with an N/S ratio of 0.30 or more and 1.00 or less when compared with C1 and C2 with an N/S ratio of less than 0.30 or greater than 1.00. From the viewpoint of suppressing an increase in ESR, the N/(C+O+S) ratio is preferably 0.033 or more and 0.050 or less. From the same viewpoint as above, the maximum thickness of the second portion is preferably 15 μm or more and 42 μm or less.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

According to the present disclosure, an increase in ESR of the solid electrolytic capacitor when exposed to a high-temperature and high-humidity environment can be suppressed. Therefore, the solid electrolytic capacitor according to the present disclosure can be used for various applications requiring high reliability, and is also useful, for example, for applications requiring high heat resistance, applications used in high-humidity environments. However, the application of the solid electrolytic capacitor is not limited thereto.

### REFERENCE NUMERALS

1: Solid electrolytic capacitor
2: Anode body
3: Dielectric layer
4: Solid electrolyte layer
5: Cathode leading layer
5a: Carbon layer
5b: Metal particle-containing layer
11: Capacitor element
12: Resin outer housing
13: Anode terminal
   13a: One end of anode terminal
   13b: Another end of anode terminal
14: Cathode terminal
   14a: One end of cathode terminal
   14b: Another end of cathode terminal
15: Cathode portion
16: Separation part
17: Conductive adhesive
E1: First end of anode body
E2: Second end of anode body
Ms: Main surface of anode body
Es: End surface of anode body
L1, L2: Straight lines extending from line segments corresponding to paired main surfaces of anode body
CL: Center line of each main surface of anode body

What is claimed is:

1. A solid electrolytic capacitor element comprising:
an anode body having a porous portion at least in a surface layer thereof,
a dielectric layer covering at least a part of the anode body, and
a cathode portion covering at least a part of the dielectric layer, wherein
the cathode portion includes a solid electrolyte layer covering at least a part of the dielectric layer,
the solid electrolyte layer contains a nitrogen element N, a sulfur element S, a carbon element C, and an oxygen element O, and has a first portion filled in voids of the porous portion of the anode body covered with the dielectric layer, and a second portion protruding from a main surface of the anode body covered with the dielectric layer, and
a mass ratio: N/S of the nitrogen element N to the sulfur element S in the second portion is 0.30 or more and 1.00 or less.

2. The solid electrolytic capacitor element according to claim 1, wherein
a mass ratio: N/(C+O+S) of the nitrogen element N to a total amount of the carbon element C, the oxygen element O, and the sulfur element S in the second portion is 0.033 or more and 0.050 or less.

3. The solid electrolytic capacitor element according to claim 1, wherein
a maximum thickness of the second portion is 15 μm or more and 42 μm or less.

4. The solid electrolytic capacitor element according to claim 1, wherein
the anode body has an anode leading portion having a first end and a cathode-forming portion having a second end, and
in a cross section, taken at an arbitrary position of a part of the solid electrolyte element on the side of the first end, perpendicular to a direction from the first end to the second end, a ratio: T1/T2 of a thickness T1 of the second portion at a corner of the anode body to a thickness T2 of the second portion at a central part of the anode body is 0.8 or more and 1.7 or less.

5. The solid electrolytic capacitor element of claim 1, wherein
the cathode portion includes a cathode leading layer covering at least a part of the solid electrolyte layer, and
the cathode leading layer includes a metal particle-containing layer.

6. The solid electrolytic capacitor element according to claim 1, wherein
the second portion contains a conjugated polymer and a dopant,
the conjugated polymer contains a monomer unit corresponding to a thiophene compound, and
the dopant has a sulfo group.

7. A solid electrolytic capacitor comprising
at least one solid electrolytic capacitor element, the at least on solid electrolytic capacitor element being the solid electrolytic capacitor element according to claim 1.
